(19) United States
(12) Patent Application Publication
(10) Pub. No.: US 2022/0138642 A1
(43) Pub. Date: May 5, 2022

(54) FORECASTING BASED ON PLANNING DATA

(71) Applicant: AT&T Intellectual Property I, L.P., Atlanta, GA (US)

(72) Inventors: Chen Li, Arlington, TX (US); Mario Kosseifi, Roswell, GA (US); Kumar Vadlamudi, Frisco, TX (US)

(21) Appl. No.: 17/087,894

(22) Filed: Nov. 3, 2020

(51) Int. Cl. G06Q 10/04; G06N 7/00; G06F 16/2458

(52) U.S. Cl. CPC G06Q 10/04; G06F 16/2474; G06N 7/005

(57) ABSTRACT

A method, computer-readable medium, and apparatus for improved forecasting for a network parameter of a communication network are disclosed. For example, a processing system including at least one processor may provide improved forecasting for a network parameter of a communication network based on determining an initial forecast for the network parameter, determining a forecast correction for the network parameter based on use of planning data associated with the network parameter of the communication network (e.g., one or more planning data factors known or expected to influence the network parameter), and determining an updated forecast for the network parameter based on modification of the initial forecast for the network parameter based on the forecast correction for the network parameter. For example, the processing system also may use the updated forecast for the network parameter to initiate one or more management actions for the communication network.

The present disclosure relates generally to communication systems and, more particularly but not exclusively, to methods, computer-readable media, and apparatuses for supporting forecasting for various parameters of communication systems.

### SUMMARY

In one example, the present disclosure describes a method, computer-readable medium, and apparatus for determining a forecast for a network parameter. For instance, a processing system including at least one processor may obtain historical time series data for a network parameter associated with a communication network, obtain, for a factor associated with the network parameter, time series data for the factor including historical time series data for the factor and planned time series data for the factor, determine, based on a forecasting model and the historical time series data for the network parameter, initial forecast data for the network parameter, determine, based on the forecasting model and the historical time series data for the factor, forecast time series data for the factor, determine, based on the planned time series data for the factor and the forecast time series data for the factor, forecast differential data for the factor, determine, based on the historical time series data for the network parameter and the historical time series data for the factor, a weight for the forecast differential data for the factor, determine, based on the weight for the forecast differential data for the factor and the forecast differential data for the factor, differentiator data for the factor, determine, based on the differentiator data for the factor, forecast correction data for the network parameter, determine, based on the initial forecast data for the network parameter and the forecast correction data for the network parameter, updated forecast data for the network parameter, and initiate, based on the updated forecast data for the network parameter, a management action associated with the communication network.

### BRIEF DESCRIPTION OF THE DRAWINGS

The teachings of the present disclosure can be readily understood by considering the following detailed description in conjunction with the accompanying drawings, in which:

FIG. 1 illustrates an example system related to the present disclosure;

FIG. 2 illustrates a flowchart of an example method for determining a forecast for a network parameter, according to the present disclosure;

FIG. 3 illustrates a flowchart of an example method for determining a forecast for a network parameter, according to the present disclosure;

FIG. 4 illustrates examples of a tentative forecast of a network parameter and an improved forecast of the network parameter which is an improvement of the tentative forecast of the network parameter, according to the present disclosure; and

FIG. 5 illustrates a high-level block diagram of a computing device specially configured to perform the functions, methods, operations, and algorithms described herein.

To facilitate understanding, identical reference numerals have been used, where possible, to designate identical elements that are common to the figures.

### DETAILED DESCRIPTION

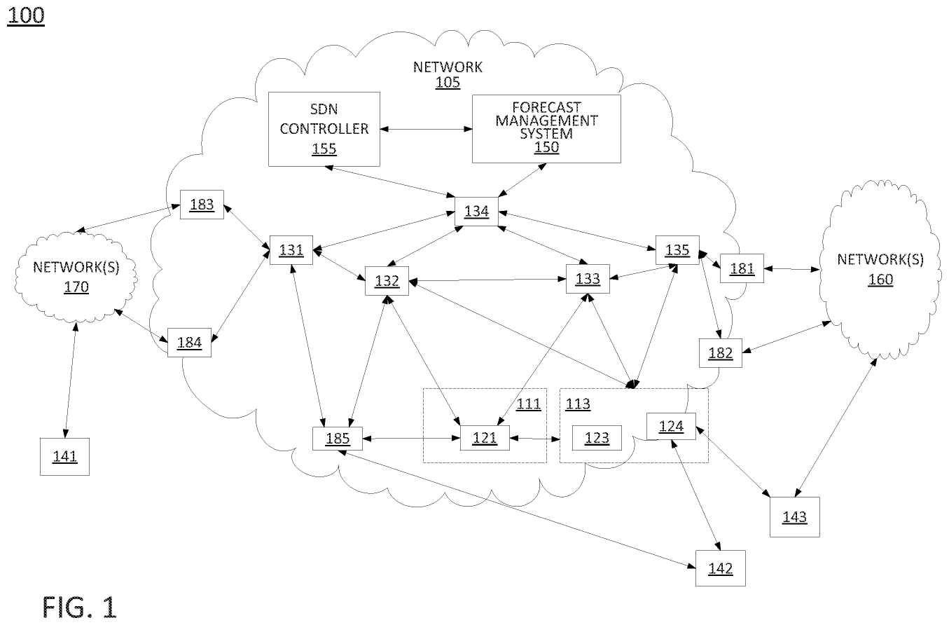

The present disclosure broadly discloses methods, computer-readable media, and apparatuses for supporting improved forecasting for communication networks. The support for improved (e.g., more accurate) forecasting for a communication network may be used to support forecasting of various network parameters associated with the communication network (e.g., network speed, network reliability, and so forth). The support for improved forecasting for a network parameter of a communication network may be based on use of planning data associated with the network parameter of the communication network (e.g., one or more planning data factors known or expected to influence the network parameter) to improve an initial, or tentative, forecast of the network parameter to provide thereby an updated, or improved, forecast of the network parameter. For instance, a processing system including at least one processor may obtain historical time series data for a network parameter to be forecasted, obtain, for a factor associated with the network parameter, time series data for the factor including historical time series data for the factor and planned time series data for the factor, determine, based on a forecasting model and the historical time series data for the network parameter, initial forecast data for the network parameter, determine, based on the forecasting model and the historical time series data for the factor, forecast time series data for the factor, determine, based on the planned time series data for the factor and the forecast time series data for the factor, forecast differential data for the factor, determine, based on the historical time series data for the network parameter and the historical time series data for the factor, a weight for the forecast differential data for the factor, determine, based on the weight for the forecast differential data for the factor and the forecast differential data for the factor, differentiator data for the factor, determine, based on the differentiator data for the factor, forecast correction data for the network parameter, and determine, based on the initial forecast data for the network parameter and the forecast correction data for the network parameter, updated forecast data for the network parameter. For example, in the case of forecasting of network speed of a communication network—which may be useful in various contexts such as for making various business decisions related to the communication network or initiating management actions for the communication network—the planning data for the network parameter may include an amount of spectrum, a number of cells, a number of carriers, and/or various other planning data factors known or expected to impact network speed. The network parameter forecasts may be used in various ways for various purposes, such as for initiating one or more management actions for a communication network (e.g., network planning actions, network provisioning actions, network configuration actions, network reconfiguration actions, business planning actions, and so forth). These and other aspects of the present disclosure are described in greater detail below in connection with the discussion of FIGS. 1-5.

To better understand the present disclosure, FIG. 1 illustrates a block diagram depicting one example of a communication network or system 100 for performing or enabling the steps, functions, operations, and/or features described herein. The system 100 may include any number of interconnected networks which may use the same or different communication technologies. As illustrated in FIG. 1, system 100 may include a network 105, e.g., a core telecommunication network.

In one example, the network 105 may include a backbone network, or transport network, such as an Internet Protocol (IP)/multi-protocol label switching (MPLS) network, where label switched paths (LSPs) can be assigned for routing Transmission Control Protocol (TCP)/IP packets, User Datagram Protocol (UDP)/IP packets, and other types of protocol data units (PDUs) (broadly “traffic”). However, it will be appreciated that the present disclosure is equally applicable to other types of data units and network protocols. For instance, the network 105 may alternatively or additionally include components of a cellular core network, such as a Public Land Mobile Network (PLMN), a General Packet Radio Service (GPRS) core network, and/or an evolved packet core (EPC) network, an Internet Protocol Multimedia Subsystem (IMS) network, a Voice over Internet Protocol (VoIP) network, and so forth. In one example, the network 105 uses a network function virtualization infrastructure (NFVI), e.g., servers in a data center or data centers that are available as host devices to host virtual machines (VMs) including virtual network functions (VNFs). In other words, at least a portion of the network 105 may incorporate software-defined network (SDN) components. In this regard, it should be noted that, as referred to herein, “traffic” may include all or a portion of a transmission, e.g., a sequence or flow, including one or more packets, segments, datagrams, frames, cells, PDUs, service data unit, bursts, and so forth. The particular terminology or types of data units involved may vary depending upon the underlying network technology. Thus, the term “traffic” is intended to refer to any quantity of data to be sent from a source to a destination through one or more networks.

In one example, the network 105 may be in communication with networks 160 and networks 170. Networks 160 and 170 may each include a wireless network (e.g., an Institute of Electrical and Electronics Engineers (IEEE) 802.11/Wi-Fi network and the like), a cellular access network (e.g., a Universal Terrestrial Radio Access Network (UTRAN) or an evolved UTRAN (eUTRAN), and the like), a circuit switched network (e.g., a public switched telephone network (PSTN)), a cable network, a digital subscriber line (DSL) network, a metropolitan area network (MAN), an Internet service provider (ISP) network, a peer network, and the like. In one example, the networks 160 and 170 may include different types of networks. In another example, the networks 160 and 170 may be the same type of network. The networks 160 and 170 may be controlled or operated by a same entity as that of network 105 or may be controlled or operated by one or more different entities. In one example, the networks 160 and 170 may include separate domains, e.g., separate routing domains from the network 105. In one example, networks 160 and/or networks 170 may represent the Internet in general.

In one example, network 105 may transport traffic to and from user devices 141-143. For instance, the traffic may relate to communications such as voice telephone calls, video and other multimedia, text messaging, emails, and so forth among the user devices 141-143, or between the user devices 141-143 and other devices that may be accessible via networks 160 and 170. For instance, the traffic may relate to management actions performed on the network 105 (e.g., management actions such as create/update/delete (CRUD) operations, queries, and so forth). User devices 141-143 may include, for example, cellular telephones, smart phones, personal computers, other wireless and wired computing devices, private branch exchanges, customer edge (CE) routers, media terminal adapters, cable boxes, home gateways and/or routers, and so forth.

In one example, user devices 141-143 may communicate with or may communicate via network 105 in various ways. For example, user device 141 may include a cellular telephone which may connect to network 105 via network 170, e.g., a cellular access network. For instance, such an example network 170 may include one or more cell sites, e.g., including a base transceiver station (BTS), a NodeB, an evolved NodeB (eNodeB), or the like (broadly a “base station”), a remote radio head (RRH) and baseband unit, a base station controller (BSC) or radio network controller (RNC), and so forth. In addition, in such an example, components 183 and 184 in network 105 may include a serving gateway (SGW), a mobility management entity (MME), or the like. In one example, user device 142 may include a customer edge (CE) router which may provide access to network 105 for additional user devices (not shown) which may be connected to the CE router. For instance, in such an example, component 185 may include a provider edge (PE) router.

As mentioned above, various components of network 105 may include virtual network functions (VNFs) which may physically include hardware executing computer-readable/computer-executable instructions, code, and/or programs to perform various functions. As illustrated in FIG. 1, units 123 and 124 may reside on a network function virtualization infrastructure (NFVI) 113, which is configurable to perform a broad variety of network functions and services. For example, NFVI 113 may include shared hardware, e.g., one or more host devices including line cards, central processing units (CPUs), or processors, memories to hold computer-readable/computer-executable instructions, code, and/or programs, and so forth. For instance, in one example unit 123 may be configured to be a firewall, a media server, a Simple Network Management protocol (SNMP) trap, etc., and unit 124 may be configured to be a PE router, e.g., a virtual provide edge (VPE) router, which may provide connectivity to network 105 for user devices 142 and 143. In one example, NFVI 113 may represent a single computing device. Accordingly, units 123 and 124 may physically reside on the same host device. In another example, NFVI 113 may represent multiple host devices such that units 123 and 124 may reside on different host devices. In one example, unit 123 and/or unit 124 may have functions that are distributed over a plurality of host devices. For instance, unit 123 and/or unit 124 may be instantiated and arranged (e.g., configured/programmed via computer-readable/computer-executable instructions, code, and/or programs) to provide for load balancing between two processors and several line cards that may reside on separate host devices.

In one example, network 105 may also include an additional NFVI 111. For instance, unit 121 may be hosted on NFVI 111, which may include host devices having the same or similar physical components as NFVI 113. In addition, NFVI 111 may reside in a same location or in different locations from NFVI 113. As illustrated in FIG. 1, unit 121 may be configured to perform functions of an internal component of network 105. For instance, due to the connections available to NFVI 111, unit 121 may not function as a PE router, a SGW, a MME, a firewall, etc. Instead, unit 121 may be configured to provide functions of components that do not utilize direct connections to components external to network 105, such as a call control element (CCE), a media server (MS), a domain name service (DNS) server, a packet data network gateway (PGW), a gateway mobile switching center (GMSC), a short message service center (SMSC), etc.

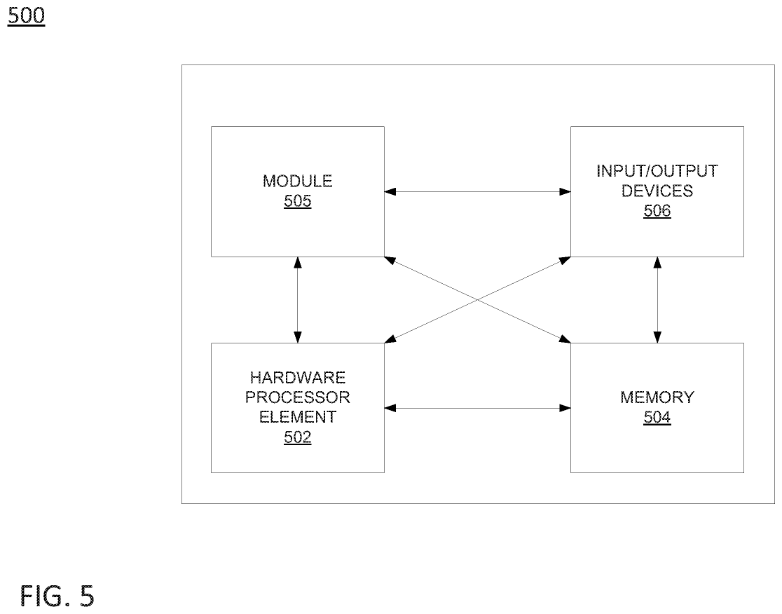

In one example, network 105 includes a software defined network (SDN) controller 155. In one example, the SDN controller 155 may comprise a computing device or processing system (e.g., a server), such as computing system 500 depicted in FIG. 5, and may be configured to provide one or more operations or functions in connection with examples of the present disclosure for supporting forecasting for communication networks.

In one example, NFVI 111 and unit 121, and NFVI 113 and units 123 and 124 may be controlled and managed by the SDN controller 155. For instance, in one example, SDN controller 155 is responsible for such functions as provisioning and releasing instantiations of VNFs to perform the functions of routers, switches, and other devices, provisioning routing tables and other operating parameters for the VNFs, and so forth. In one example, SDN controller 155 may maintain communications with VNFs and/or host devices/NFVI via a number of control links which may include secure tunnels for signaling communications over an underling IP infrastructure of network 105. In other words, the control links may include virtual links multiplexed with transmission traffic and other data traversing network 105 and carried over a shared set of physical links. For ease of illustration the control links are omitted from FIG. 1. In one example, the SDN controller 155 also may include a virtual machine operating on NFVI/host device(s), or may include a dedicated device. For instance, SDN controller 155 may be collocated with one or more VNFs, or may be deployed in a different host device or at a different physical location.

In one example, the functions of SDN controller 155 may include the selection of NFVI from among various NFVI available in network 105 (e.g., NFVI 111 or 113) to host various devices, such as routers, gateways, switches, etc., and the instantiation of such devices. For example, with respect to units 123 and 124, SDN controller 155 may download computer-executable/computer-readable instructions, code, and/or programs (broadly “configuration code”) for units 123 and 124 respectively, which when executed by a processor of the NFVI 113, may cause the NFVI 113 to perform as a PE router, a gateway, a route reflector, a SGW, a MME, a firewall, a media server, a DNS server, a PGW, a GMSC, a SMSC, a CCE, and so forth. In one example, SDN controller 155 may download the configuration code to the NFVI 113. In another example, SDN controller 155 may instruct the NFVI 113 to load the configuration code previously stored on NFVI 113 and/or to retrieve the configuration code from another device in network 105 that may store the configuration code for one or more VNFs. The functions of SDN controller 155 may also include releasing or decommissioning unit 123 and/or unit 124 when no longer required, the transferring of the functions of units 123 and/or 124 to different NFVI, e.g., when NVFI 113 is taken offline, and so on.

In one example, SDN controller 155 may represent a processing system including a plurality of controllers, e.g., a multi-layer SDN controller, one or more federated layer 0/physical layer SDN controllers, and so forth. For instance, a multi-layer SDN controller may be responsible for instantiating, tearing down, configuring, reconfiguring, and/or managing layer 2 and/or layer 3 VNFs (e.g., a network switch, a layer 3 switch and/or a router, etc.), whereas one or more layer 0 SDN controllers may be responsible for activating and deactivating optical networking components, for configuring and reconfiguring the optical networking components (e.g., to provide circuits/wavelength connections between various nodes or to be placed in idle mode), for receiving management and configuration information from such devices, and so forth. In one example, the layer 0 SDN controller(s) may in turn be controlled by the multi-layer SDN controller. For instance, each layer 0 SDN controller may be assigned to nodes/optical components within a portion of the network 105. In addition, these various components may be co-located or distributed among a plurality of different dedicated computing devices or shared computing devices (e.g., NFVI) as described herein.

In one example, the network 105 may also include internal nodes 131-135, which may include various components, such as routers, switches, route reflectors, etc., cellular core network, IMS network, and/or VoIP network components, and so forth. In one example, these internal nodes 131-135 may also include VNFs hosted by and operating on additional NFVIs. For instance, as illustrated in FIG. 1, internal nodes 131 and 135 may include VNFs residing on additional NFVI (not shown) that are controlled by SDN controller 155 via additional control links. However, at least a portion of the internal nodes 131-135 may include dedicated devices or components, e.g., non-SDN reconfigurable devices.

In one example, the network 105 may also include components 181 and 182, e.g., PE routers interfacing with networks 160, and component 185, e.g., a PE router which may interface with user device 142. For instance, in one example, network 105 may be configured such that user device 142 (e.g., a CE router) is dual-homed. In other words, user device 142 may access network 105 via either or both of unit 124 and component 185. As mentioned above, components 183 and 184 may include a serving gateway (SGW), a mobility management entity (MME), or the like. However, in another example, components 183 and 184 also may include PE routers interfacing with network(s) 170, e.g., for non-cellular network-based communications. In one example, components 181-185 also may include VNFs hosted by and operating on additional NFVI. However, in another example, at least a portion of the components 181-185 may include dedicated devices or components.

In one example, the network 105 includes a forecast management system 150. The forecast management system 150 may comprise a computing device or processing system (e.g., a server), such as computing system 500 depicted in FIG. 5, and may be configured to provide one or more operations or functions in connection with examples of the present disclosure for supporting forecasting for communication networks. The forecast management system 150 may determine a forecast for a subject which, within the context of the system 100, may be a subject associated with the system 100 (e.g., a network parameter that is associated with the network 105, such as a planning parameter associated with planning for the network 105 by the network provider, an operational parameter associated with operation of the network 105 by the network provider, and so forth).

The forecast management system 150 may determine a forecast for a network parameter of the network 105. The network parameter for which the forecast is to be determined may be any suitable parameter which may be forecast for the network 105, such as a parameter associated with the capacity of the network 105 (e.g., available capacity, utilized capacity, and so forth), a parameter associated with the transport of traffic via the network 105 (e.g., network speed, network latency, network reliability, and so forth), or the like. The network parameter for which the forecast is determined may be determined for various purposes, such as for performing planning for the network 105 (e.g., in which case the forecast of the network parameter may be provided to one or more devices or systems of the network provider associated with planning for the network 105), for performing management of the network 105 (e.g., in which case the forecast of the network parameter may be provided to one or more devices or systems of the network provider associated with management of the network 105), for marketing and/or advertising for the network 105 (e.g., in which case the forecast of the network parameter may be provided to one or more devices or systems of the network provider associated with marketing and/or advertising for the network 105), and so forth. It will be appreciated that forecasting may be performed for various other types of parameters, may be performed for various other purposes, and so forth.

The forecast management system 150 may determine the forecast for the network parameter in various ways. The forecast management system 150 may determine the forecast for the network parameter by determining an initial forecast for the network parameter (e.g., initial forecast data which may be time series data) and modifying the initial forecast for the network parameter to obtain an updated forecast for the network parameter (e.g., updated forecast data which may be time series data) based on a forecast correction (e.g., forecast correction data which may be time series data). The forecast management system 150 may determine the forecast for the network parameter by determining initial forecast data for the network parameter, determining forecast correction data for the network parameter, and modifying the initial forecast data for the network parameter based on the forecast correction data for the network parameter to obtain updated forecast data for the network parameter. The forecast management system 150 may determine the forecast for the network parameter by determining initial forecast data for the network parameter, determining forecast correction data for the network parameter based on data associated with a set of factors associated with the network parameter (e.g., factors that are known or expected to influence the network parameter), and modifying the initial forecast data for the network parameter based on the forecast correction data for the network parameter to obtain updated forecast data for the network parameter. The forecast management system 150 may determine the forecast for the network parameter based on various types of data, various data modeling and analysis capabilities, and so forth.

The forecast management system 150 may determine the forecast for a network parameter of the network 105 based on various types of data. The forecast management system 150 may determine the forecast for the network parameter based on time series data (e.g., where the time series data may be over a time horizon which may include one or more specific times or time periods under consideration), which may include time series data for the forecasts (e.g., tentative and improved forecasts) and time series data which may be used in determining the forecasts. The forecast management system 150 may determine the forecast for the network parameter based on various categories of data (e.g., historical data, planned data, forecast (or predicted) data, and so forth) which may be obtained in various ways (e.g., historical data from one or more operations support systems (OSSs) or business support systems (BSSs) of the network provider of the network 105, planned data from one or more planning systems of the network provider of the network 105, forecast data computed based on various data modeling and/or data analysis techniques, and so forth). The forecast management system 150 may determine the forecast for the network parameter using time series data associated with the network parameter. The forecast management system 150 may determine the forecast for the network parameter using historical time series data of the network 105 and planning time series data of the network 105. The forecast management system 150 may determine the forecast for the network parameter using historical time series data for the network parameter. The forecast management system 150 may determine the forecast for the network parameter using time series data for each factor in a set of one or more factors associated with the network parameter. The one or more factors in the set of factors associated with the network parameter may include factors known or expected to influence the network parameter. The time series data for each factor in the set of factors may include historical time series data for the factor, planned time series data for the factor, and forecast time series data for the factor. The forecast management system 150 may determine the forecast for the network parameter based on various other types of data.

The forecast management system 150 may determine the forecast for a network parameter of the network 105 using various data modeling and analysis capabilities. The forecast management system 150 may determine the forecast for the network parameter based on a forecasting model. The forecast management system 150 may determine the forecast for the network parameter based on use of a time series forecasting model. For example, the time series forecasting model may be Auto Regressive Integrated Moving Average (ARIMA), PROPHET, or the like. The forecast management system 150 may determine the forecast for the network parameter based on use of regression techniques. For example, the regression techniques may include linear regression techniques. The forecast management system 150 may determine the forecast for the network parameter based on various other data modeling and analysis techniques.

The forecast management system 150 may determine the forecast for the network parameter in various ways. The forecast management system 150 may determine a forecast for a network parameter by determining initial forecast data for the network parameter, determining forecast correction data for the network parameter, and determining updated forecast data for the network parameter based on modification of the initial forecast data for the network parameter based on the forecast correction data for the network parameter.

The forecast management system 150 may determine the initial forecast data for the network parameter in various ways. The forecast management system 150 may determine the initial forecast data for the network parameter based on historical time series data for the network parameter. The forecast management system 150 may determine the initial forecast data for the network parameter by obtaining the historical time series data for the network parameter and determining, based on a forecasting model and the historical time series data for the network parameter, the initial forecast data for the network parameter. The forecast management system 150 may determine the initial forecast data for the network parameter in various other ways.

The forecast management system 150 may determine the forecast correction data for the network parameter in various ways. The forecast management system 150 may determine the forecast correction data for the network parameter based on planning data associated with the network parameter (e.g., based on one or more factors associated with the network parameter and known or expected to impact or influence the network parameter). The forecast management system 150 may determine the forecast correction data for the network parameter based on various types of information, various data modeling and analysis techniques, and so forth.

The forecast management system 150 may determine the forecast correction data for the network parameter based on various types of information. The forecast management system 150 may determine the forecast correction data for the network parameter based on historical information associated with the network parameter and planning data associated with the network parameter (e.g., data associated with one or more factors known or expected to impact the network parameter). The forecast management system 150 may determine the forecast correction data for the network parameter based on the historical time series data for the network parameter. The forecast management system 150 may determine the forecast correction data for the network parameter based on time series data for one or more factors associated with the network parameter (e.g., the time series data for the one or more factors associated with the network parameter may include, for each factor in the set of factors, historical time series data for the factor, planning time series data for the factor, and forecast time series data for the factor). The forecast management system 150 may determine the forecast correction data for the network parameter based on various other types of information.

The forecast management system 150 may determine the forecast correction data for the network parameter based on various types of data modeling and analysis techniques. The forecast management system 150 may determine the forecast correction data for the network parameter based on the forecasting model used to determine the initial forecast data for the network parameter. The forecast management system 150 may determine the forecast correction data for the network parameter by determining, based on application of the forecasting model to historical data for the factors associated with the network parameter (e.g., historical time series data for the factors), forecast data for the factors associated with the network parameter (e.g., forecast time series data for the one or more factors). The forecast management system 150 may determine the forecast correction data for the network parameter based on use of linear regression techniques to determine the effect of the factors associated with the network parameter on the network parameter. The forecast management system 150 may determine the forecast correction data for the network parameter based on various other types of data modeling and analysis techniques.

The forecast management system 150 may determine the forecast correction data for the network parameter based on comparison of planning data for the factors associated with the network parameter (e.g., planned time series data for the one or more factors) and the forecast data for the factors associated with the network parameter (e.g., forecast time series data for the one or more factors) to measure the forecast data for the factors associated with the network parameter against the planning data for the factors associated with the network parameter (which may be referred to herein as differentials for the factors associated with the network parameter). The forecast management system 150 may determine the forecast correction data for the network parameter by using linear regression, based on the historical data for the network parameter and the factors associated with the network parameter (e.g., using the historical time series data of the network parameter as an output variable of the linear regression and using the historical time series data of the factors as explanatory variables of the linear regression), to determine the effects of the factors on the network parameter (e.g., where such effects may be used as weights which may be applied to the differentials for the factors). The forecast management system 150 may determine the forecast correction data for the network parameter based on combinations of the differentials for the factors associated with the network parameter and the weights for the factors associated with the network parameter (e.g., weighting the forecast differential data for the factors based on the weights for the factors to provided weighted forecast differential data for the factors which may be referred to as differentiator data for the factors). The forecast management system 150 may determine the forecast correction data for the network parameter based on a combination of the differentiator data for the factors (e.g., aggregation of the differentiator data for the factors to obtain the forecast correction data for the network parameter).

The forecast management system 150, may determine a forecast for a network parameter in various ways. The forecast management system 150 may determine a forecast for a network parameter that is to be forecasted by obtaining historical time series data for the network parameter, obtaining, for each factor in a set of factors associated with the network parameter, respective time series data for the factor including respective historical time series data for the factor and respective planned time series data for the factor, determining, based on a forecasting model and the historical time series data for the network parameter, initial forecast data for the network parameter, determining, for each factor based on the forecasting model and the respective historical time series data for the factor, respective forecast time series data for the factor, determining, for each factor based on the respective planned time series data for the factor and the respective forecast time series data for the factor, respective forecast differential data for the factor, determining, for each factor based on the historical time series data for the network parameter and the respective time series data for the factor, a respective weight for the respective forecast differential data for the factor, determining, for each factor based on the respective weight for the respective forecast differential data for the factor and the respective forecast differential data for the factor, respective differentiator data for the factor, determining, based on an aggregation of the respective differentiator data for the factors, forecast correction data for the network parameter, and determining, based on the initial forecast data for the network parameter and the forecast correction data for the network parameter, updated forecast data for the network parameter.

It will be appreciated that the forecast management system 150 may determine the forecast for the network parameter in various other ways. For example, it will be appreciated that, although presented with respect to use of specific functions or combinations and/or arrangements of functions to determine the forecast for a network parameter, various other functions or combinations and/or arrangements of functions may be used to determine the forecast for a network parameter. For example, it will be appreciated that the various functions presented as being used for determining the forecast for the network parameter may be organized in various other ways (e.g., one or more higher level functions may be split into multiple lower level functions, various lower level functions may be combined into a single higher level function, and so forth). For example, it will be appreciated that the forecast for the network parameter may be determined based on various other data, various other data modeling and analysis techniques, and so forth.

The forecast management system 150 may use the forecast for the network parameter to initiate one or more management actions for the network 105. For example, the forecast management system 150 may request a change in the capacity of the network 105 and/or initiate a network capacity provisioning action for implementing a change in the capacity of the network 105 (e.g., capacity installed on elements of the network 105, bandwidth supported between elements of the network 105, and so forth), request a change in configuration of the network 105 and/or initiate a network configuration action for implementing a change in the network 105 (e.g., a topology change, a change to a configuration of an element of the network 105, and so forth), or the like. In one example, at least some such management actions may be initiated based on one or more of internal messaging within the forecast management system 150 (e.g., where the forecast management system 150 is configured to perform the management action), based on sending of one or more messages from the forecast management system 150 to one or more other systems (e.g., network capacity provisioning systems, network capacity management systems, element management systems, network management systems, OSSs, BSSs, marketing control systems, advertising control systems, or the like), and so forth.

It will be appreciated that the forecast management system 150 may be configured to perform various other functions for supporting forecasting for communication networks such as the network 105, as discussed further herein.

It should be noted that the system 100 has been simplified. In other words, the system 100 may be implemented in a different form than that illustrated in FIG. 1. For example, the system 100 may be expanded to include additional networks (e.g., a content distribution network (CDN), a network operations center (NOC) network, and the like), additional network devices (e.g., border devices, routers, switches, policy servers, security devices, gateways, and the like), and so forth, without altering the scope of the present disclosure. In addition, system 100 may be altered to omit various elements, substitute elements for devices that perform the same or similar functions and/or combine elements that are illustrated as separate devices. For example, SDN controller 155, forecast management system 150, and/or other network devices may include functions that are spread across several devices that operate collectively as a SDN controller, a forecast management system, an edge device, and so forth. Thus, these and other modifications of the system 100 are all contemplated within the scope of the present disclosure.

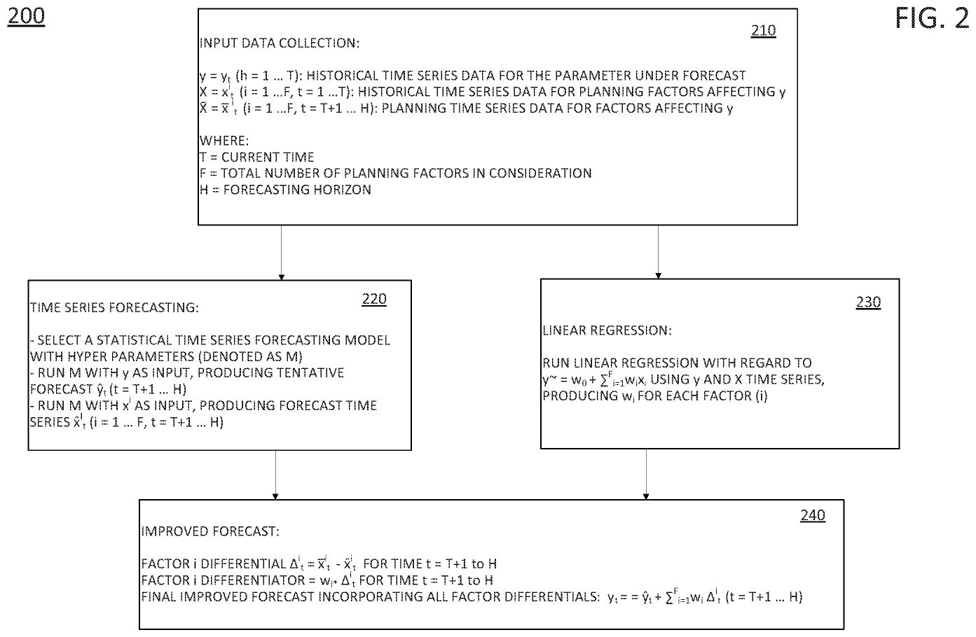

FIG. 2 illustrates a flowchart of an example method for determining a forecast for a network parameter, according to the present disclosure. In one example, the blocks, steps, operations, or functions of the method 200 may be performed by any one or more of the components of the system 100 depicted in FIG. 1. In one example, the method 200 is performed by a management system (e.g., forecast management system 150). In one example, the blocks, steps, functions, or operations of method 200 may be performed by a computing device or processing system, such as computing system 500 and/or a hardware processor element 502 as described in connection with FIG. 5 below. For instance, the computing system 500 may represent at least a portion of a management system in accordance with the present disclosure. In one example, the blocks, steps, functions, or operations of method 200 may be performed by a processing system comprising a plurality of such computing devices as represented by the computing system 500. For illustrative purposes, the method 200 is described in greater detail below in connection with an example performed by a processing system.

In block 210, the processing system collects input information. The processing system collects historical time series data for the network parameter to be forecasted for time series analysis (which may be denoted as y=yₜ (h=1 . . . T)). The processing system determines a set of factors that influence, or may influence, the network parameter being forecasted and collects time series data for each of the factors. The time series data for each of the factors may include historical time series data for each of the factors (denoted as X=xⁱₜ (i=1 . . . F, t=1 . . . T)) and planned time series data for each of the factors (denoted as X̅=x̅ⁱₜ (i=1 . . . F, t=T+1 . . . H)). For example, the time series data for each of the factors may be obtained from a business planning database or other suitable source of such time series data. The time series data for the factors that influence, or may influence, the network parameter will be used to improve the accuracy of the forecast of the network parameter.

In block 220, the processing system performs time series forecasting. The processing system may select a time-series based statistical forecasting model (e.g., ARIMA, PROPHET, or the like) and use the historical time series data for the network parameter to produce a tentative (initial) forecast for the network parameter, at time t, which is denoted as ŷₜ. This forecast for the network parameter, in theory incorporates all known and unknown factors based on historical data. The processing system, for each factor (i) in the selected set of factors, applies the same time series analysis model used for the tentative forecast for the network parameter, based on the historical time series data for the factor (i), to produce a forecast for the factor (i), at time t, which is denoted as \hat{x}ⁱₜ.

In block 230, the processing system performs linear regressions to determine weights wᵢ to be applied to differentials, denoted as Δⁱₜ for the factors (i), which will be computed for the factors (i). The linear regression for a factor (i), performed to determine the weight wᵢ for the factor (i), may be performed using the historical time series data for the network parameter (y) as the output variable and the historical time series data for the factor (i) (xⁱₜ) as the explanatory variable. It is noted that these may be considered to be “best effort” linear regressions. The linear regression performed for a factor (i) provides an indication of the effect of the factor (i) on the network parameter.

In block 240, the processing system determines the improved forecast for the network parameter. The processing system, for each factor (i), produces a differential for the factor (i), denoted as Δⁱₜ, as a difference between the planned time series data for the factor (i) (denoted as xⁱₜ) and the forecast time series data for the factor (i) (denoted as \hat{x}ⁱₜ), which may be represented as Δⁱₜ=x̅ⁱₜ−\hat{x}ⁱₜ. The processing system, for each factor (i), produces a differentiator for the factor (i) as a product of the weight wᵢ for the factor (i) and the differential Δⁱₜ for the factor (i), which is denoted as (wᵢ*Δⁱₜ). The processing system applies the differentiators (wᵢ*Δⁱₜ) for the factors (i), based on aggregation of the differentiators (wᵢ*Δⁱₜ) for the factors (i), as a correction to the tentative forecast for the network parameter in order to provide an improved forecast for the network parameter (denoted as yₜ), which may be represented as yₜ=ŷₜ+Σ^{F}ᵢ₌₁wᵢ Δⁱₜ, where Σ^{F}ᵢ₌₁ is summation of the F factors associated with the network parameter.

It will be appreciated that method 200 of FIG. 2 may be modified in various ways while still supporting improved forecasting for a network parameter. For example, the various functions of various blocks of the method 200 may be performed contemporaneously, in a different order than as presented in FIG. 2, and so forth. For example, the various functions of the various blocks of the method 200 may be organized in various other ways (e.g., using fewer or more blocks, using different arrangements of the functions within or across the blocks, and so forth).

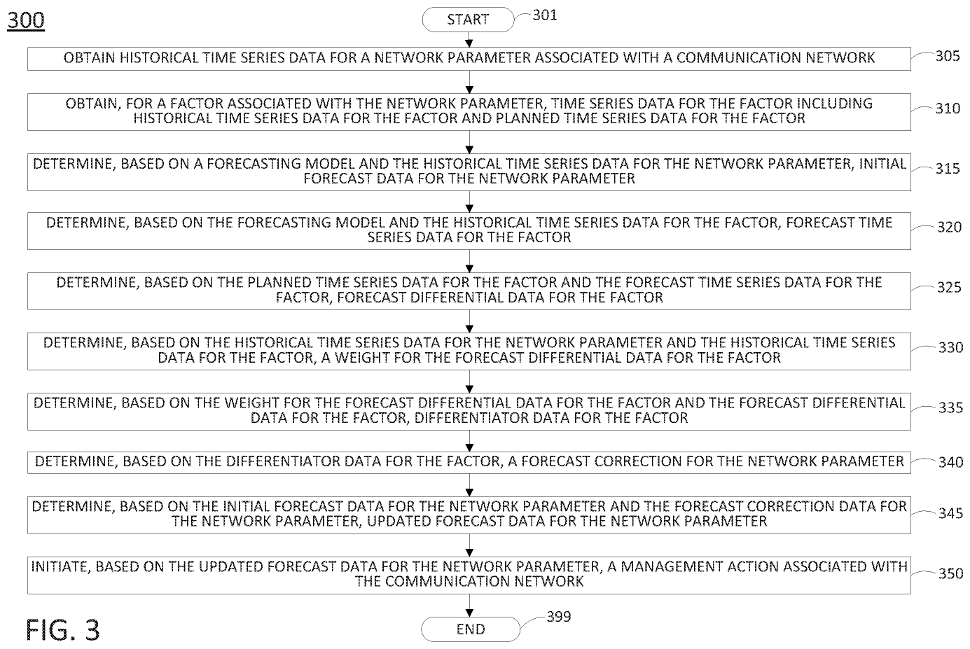

FIG. 3 illustrates a flowchart of an example method for determining a forecast for a network parameter. In one example, the steps, operations, or functions of the method 300 may be performed by any one or more of the components of the system 100 depicted in FIG. 1. In one example, the method 300 is performed by a management system (e.g., forecast management system 150). In one example, the steps, functions, or operations of method 300 may be performed by a computing device or processing system, such as computing system 500 and/or a hardware processor element 502 as described in connection with FIG. 5 below. For instance, the computing system 500 may represent at least a portion of a management system in accordance with the present disclosure. In one example, the steps, functions, or operations of method 300 may be performed by a processing system comprising a plurality of such computing devices as represented by the computing system 500. For illustrative purposes, the method 300 is described in greater detail below in connection with an example performed by a processing system.

The method 300 begins in step 301 and proceeds to step 305. At step 305, the processing system obtains historical time series data for a network parameter associated with a communication network. The network parameter is the parameter to be forecasted.

At step 310, the processing system obtains, for a factor associated with the network parameter, time series data for the factor including historical time series data for the factor and planned time series data for the factor. The factor may be selected based on a determination that the factor impacts the network parameter. The time series data for the factor may be obtained from a business planning system.

At step 315, the processing system determines, based on a forecasting model and the historical time series data for the network parameter, initial forecast data for the network parameter. The forecasting model may be a time series forecasting model. The time series forecasting model may be an auto regressive integrated moving average model or a prophet model.

At step 320, the processing system determines, based on the forecasting model and the historical time series data for the factor, forecast time series data for the factor. The forecast time series data for the factor may be over the same forecast horizon as the initial forecast data for the network parameter.

At step 325, the processing system determines, based on the planned time series data for the factor and the forecast time series data for the factor, forecast differential data for the factor. The forecast differential data for the factor may be determined based on at least one difference between the planned time series data for the factor and the forecast time series data for the factor (e.g., based on differences between values at each of the times of the time series data).

At step 330, the processing system determines, based on the historical time series data for the network parameter and the historical time series data for the factor, a weight for the forecast differential data for the factor. The weight for the forecast differential data for the factor may be determined using a linear regression. The linear regression may be configured to quantify an effect of the factor on the network parameter. The linear regression may use the historical time series data for the network parameter as an output variable and the historical time series data for the factor as an explanatory variable.

At step 335, the processing system determines, based on the weight for the forecast differential data for the factor and the forecast differential data for the factor, differentiator data for the factor. The differentiator data for the factor may be determined as at least one product of the weight for the forecast differential data for the factor and the forecast differential data for the factor (e.g., products of the weight with values of the forecast differential data at each of the times of the time series data).

At step 340, the processing system determines, based on the differentiator data for the factor, forecast correction data for the network parameter. The forecast correction data for the network parameter may be determined by setting the forecast correction data for the network parameter equal to the differentiator data for the factor (e.g., where a single factor is used).

At step 345, the processing system determines, based on the initial forecast data for the network parameter and the forecast correction data for the network parameter, updated forecast data for the network parameter. The updated forecast data for the network parameter may be determined as a sum of the initial forecast data for the network parameter and the forecast correction data for the network parameter.

At step 350, the processing system initiates, based on the updated forecast data for the network parameter, a management action associated with the communication network. The management action may include at least one of a network capacity provisioning action or a network configuration action.

Following step 350, the method 300 proceeds to step 399 where the method 300 ends.

In addition, although not specifically specified, one or more steps, functions, or operations of the method 300 may include a storing, displaying and/or outputting step as required for a particular application. In other words, any data, records, fields, and/or intermediate results discussed in the method 300 can be stored, displayed, and/or outputted either on the device executing the respective method or to another device, as required for a particular application.

Furthermore, steps, blocks, functions, or operations in FIG. 3 that recite a determining operation or involve a decision do not necessarily require that both branches of the determining operation be practiced. In other words, one of the branches of the determining operation can be deemed as an optional step. Moreover, steps, blocks, functions, or operations of the above-described method 300 can be combined, separated, omitted, and/or performed in a different order from that described above, without departing from the examples of the present disclosure.

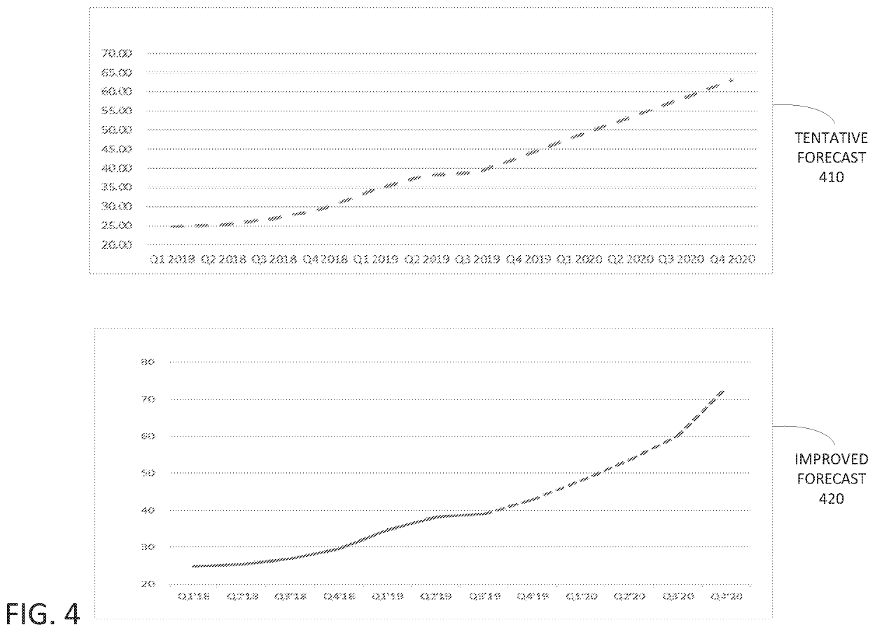

FIG. 4 illustrates examples of a tentative forecast of a network parameter and an improved forecast of the network parameter which is an improvement of the tentative forecast of the network parameter. In the example of FIG. 4, the network parameter is network speed, which is measured in megabits per second (Mbps). The forecast of the network speed is improved based on one or more factors associated with network speed (e.g., an amount of spectrum, a number of cells, or a number of carriers, and so forth). The timeline of the example is expressed quarterly and begins in the first quarter (Q1) of 2018 and extends until the fourth quarter (Q4) of 2020. The tentative forecast 410, which is not based on planning data for factors associated with network speed, shows a linear increase in network speed from 40 Mbps to 65 Mbps between Q3 2019 and Q4 2020. The improved forecast 420, which is based on planning data for factors associated with network speed, shows a different type of increase in network speed between Q3 2019 and Q4 2020. More specifically, the improved forecast 420 shows a linear increase in network speed from 40 Mbps to 60 Mbps between Q3 2019 and Q3 2020 where the linear increase has a first slope and a linear increase in network speed from 60 Mbps to 72 Mbps between Q3 2020 and Q4 2020 where the linear increase has a second slope greater than the first slope. Here, iₜ will be appreciated that the improved forecast 420, since iₜ is based on planning data for factors associated with network speed, provides an improvement over the tentative forecast 410 which is not based on planning data for factors associated with network speed.

It will be appreciated that, although primarily presented herein with respect to examples in which forecasts of network parameters based on factors are forecasts of time series data for multiple times or time periods based on time series data for multiple times or time periods of the factors, various examples presented herein may be used for determining forecasts of network parameters for single times or time periods based on data for single times or time periods of the factors. In such examples, references herein to time series data and data determined based on such time series data may be considered to be references to values (e.g., a forecast for a network parameter may be a forecast value of the network parameter at a particular time or for a particular time period, forecast differential data for a factor may be a forecast differential value for the factor at a particular time or for a particular time period, differentiator data for a factor may be a differentiator value for the factor at a particular time or for a particular time period, and so forth).

It will be appreciated that, although primarily presented with respect to examples in which forecasting is performed for a network parameter associated with a communication network, various examples presented herein may be applied for supporting improved forecasting for various other types of parameters, for various subjects, and so forth.

FIG. 5 depicts a high-level block diagram of a computing system 500 (e.g., a computing device, or processing system) specifically programmed to perform the functions described herein. For example, any one or more components or devices illustrated in FIG. 1 or described in connection with the method 200 of FIG. 2 or the method 300 of FIG. 3 may be implemented as the computing system 500. As depicted in FIG. 5, the computing system 500 comprises a hardware processor element 502 (e.g., comprising one or more hardware processors, which may include one or more microprocessor(s), one or more central processing units (CPUs), and/or the like, where hardware processor element may also represent one example of a “processing system” as referred to herein), a memory 504, (e.g., random access memory (RAM), read only memory (ROM), a disk drive, an optical drive, a magnetic drive, and/or a Universal Serial Bus (USB) drive), a module 505 for supporting forecasting for communication networks, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

It should be noted that, although only one hardware processor element 502 is shown, the computing device may employ a plurality of hardware processor elements. Furthermore, although only one computing device is shown in FIG. 5, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 5 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor element 502 can also be configured or programmed to cause other devices to perform one or more operations as discussed above. In other words, the hardware processor element 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for supporting forecasting for communication networks (e.g., a software program comprising computer-executable instructions) can be loaded into memory 504 and executed by hardware processor element 502 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for supporting forecasting for communication networks (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, iₜ should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, historical time series data for a network parameter associated with a communication network;
obtaining, by the processing system, for a factor associated with the network parameter, time series data for the factor including historical time series data for the factor and planned time series data for the factor;
determining, by the processing system based on a forecasting model and the historical time series data for the network parameter, initial forecast data for the network parameter;
determining, by the processing system based on the forecasting model and the historical time series data for the factor, forecast time series data for the factor;
determining, by the processing system based on the planned time series data for the factor and the forecast time series data for the factor, forecast differential data for the factor;
determining, by the processing system based on the historical time series data for the network parameter and the historical time series data for the factor, a weight for the forecast differential data for the factor;
determining, by the processing system based on the weight for the forecast differential data for the factor and the forecast differential data for the factor, differentiator data for the factor;
determining, by the processing system based on the differentiator data for the factor, forecast correction data for the network parameter;
determining, by the processing system based on the initial forecast data for the network parameter and the forecast correction data for the network parameter, updated forecast data for the network parameter; and
initiating, by the processing system based on the updated forecast data for the network parameter, a management action associated with the communication network.

2. The method of claim 1, wherein the factor is selected based on a determination that the factor impacts the network parameter.

3. The method of claim 1, wherein the time series data for the factor is obtained from a business planning system.

4. The method of claim 1, wherein the forecasting model comprises a time series forecasting model.

5. The method of claim 4, wherein the time series forecasting model comprises an auto regressive integrated moving average model or a prophet model.

6. The method of claim 1, wherein the forecast differential data for the factor is determined based on at least one difference between the planned time series data for the factor and the forecast time series data for the factor.

7. The method of claim 1, wherein the weight for the forecast differential data for the factor is determined using a linear regression.

8. The method of claim 7, wherein the linear regression is configured to quantify an effect of the factor on the network parameter.

9. The method of claim 7, wherein the linear regression uses the historical time series data for the network parameter as an output variable and the historical time series data for the factor as an explanatory variable.

10. The method of claim 1, wherein the differentiator data for the factor is determined as at least one product of the weight for the forecast differential data for the factor and the forecast differential data for the factor.

11. The method of claim 1, wherein the forecast correction data for the network parameter is determined by setting the forecast correction data for the network parameter equal to the differentiator data for the factor.

12. The method of claim 1, wherein the updated forecast data for the network parameter is determined as a sum of the initial forecast data for the network parameter and the forecast correction data for the network parameter.

13. The method of claim 1, further comprising:
determining, by the processing system, for a second factor associated with the network parameter, differentiator data for the second factor.

14. The method of claim 13, wherein the determining the differentiator data for the second factor comprises:
obtaining, by the processing system for the second factor, time series data for the second factor including historical time series data for the second factor and planned time series data for the second factor;
determining, by the processing system based on the forecasting model and the historical time series data for the second factor, forecast time series data for the second factor;
determining, by the processing system based on the planned time series data for the second factor and the forecast time series data for the second factor, forecast differential data for the second factor;
determining, by the processing system based on the historical time series data for the network parameter and the historical time series data for the second factor, a weight for the forecast differential data for the second factor; and
determining, by the processing system based on the weight for the forecast differential data for the second factor and the forecast differential data for the second factor, the differentiator data for the second factor.

15. The method of claim 13, wherein the forecast correction data for the network parameter is determined based on the differentiator data for the factor and the differentiator data for the second factor.

16. The method of claim 1, wherein the management action comprises at least one of a network capacity provisioning action or a network configuration action.

17. The method of claim 1, wherein the network parameter comprises a network speed parameter, wherein the factor comprises an amount of spectrum, a number of cells, or a number of carriers.

18. The method of claim 1, wherein the network parameter comprises a network capacity parameter, a network speed parameter, or a network reliability parameter.

19. A non-transitory computer-readable medium storing instructions which, when executed by a processing system including at least one processor, cause the processing system to perform operations, the operations comprising:
obtaining historical time series data for a network parameter associated with a communication network;
obtaining, for a factor associated with the network parameter, time series data for the factor including historical time series data for the factor and planned time series data for the factor;
determining, based on a forecasting model and the historical time series data for the network parameter, initial forecast data for the network parameter;
determining, based on the forecasting model and the historical time series data for the factor, forecast time series data for the factor;
determining, based on the planned time series data for the factor and the forecast time series data for the factor, forecast differential data for the factor;
determining, based on the historical time series data for the network parameter and the historical time series data for the factor, a weight for the forecast differential data for the factor;
determining, based on the weight for the forecast differential data for the factor and the forecast differential data for the factor, differentiator data for the factor;
determining, based on the differentiator data for the factor, forecast correction data for the network parameter;
determining, based on the initial forecast data for the network parameter and the forecast correction data for the network parameter, updated forecast data for the network parameter; and
initiating, based on the updated forecast data for the network parameter, a management action associated with the communication network.

20. An apparatus comprising:
a processing system including at least one processor; and
a computer-readable medium storing instructions which, when executed by the processing system, cause the processing system to perform operations, the operations comprising:
obtaining historical time series data for a network parameter associated with a communication network;
obtaining, for a factor associated with the network parameter, time series data for the factor including historical time series data for the factor and planned time series data for the factor;
determining, based on a forecasting model and the historical time series data for the network parameter, initial forecast data for the network parameter;
determining, based on the forecasting model and the historical time series data for the factor, forecast time series data for the factor;
determining, based on the planned time series data for the factor and the forecast time series data for the factor, forecast differential data for the factor;
determining, based on the historical time series data for the network parameter and the historical time series data for the factor, a weight for the forecast differential data for the factor;
determining, based on the weight for the forecast differential data for the factor and the forecast differential data for the factor, differentiator data for the factor;
determining, based on the differentiator data for the factor, forecast correction data for the network parameter;
determining, based on the initial forecast data for the network parameter and the forecast correction data for the network parameter, updated forecast data for the network parameter; and
initiating, based on the updated forecast data for the network parameter, a management action associated with the communication network.
